(19) United States
(12) Patent Application Publication
(10) Pub. No.: US 2019/0087492 A1
(43) Pub. Date: Mar. 21, 2019

(54) METHOD AND APPARATUS FOR QUERYING INFORMATION

(71) Applicant: Baidu Online Network Technology (Beijing) Co., Ltd., Beijing (CN)

(72) Inventors: Binjie WU, Beijing (CN); Hui YUAN, Beijing (CN); Yinan ZHANG, Beijing (CN)

(21) Appl. No.: 16/105,587

(22) Filed: Aug. 20, 2018

(30) Foreign Application Priority Data
Sep. 18, 2017 (CN) 201710840112.1

(51) Int. Cl. G06F 17/30; G01C 21/36

(52) U.S. Cl. CPC G06F 17/30817; G01C 21/3691; G06F 17/30241

(57) ABSTRACT

Embodiments of the present disclosure disclose a method and apparatus for querying information. A specific embodiment of the method includes: acquiring a driving route, a driving record video, and a record file; reading the event information in the record file, acquiring driving information corresponding to the event information from the driving record video, and acquiring pending prompt information provided by the electronic map and corresponding to the event information and the driving route; and establishing a corresponding relationship between the event information, the driving information, and the pending prompt information, and establishing an information query table based on the corresponding relationship. This embodiment facilitates timely correction of the prompt information of the electronic map, and improves the accuracy of the prompt information of the electronic map.

### CROSS-REFERENCE TO RELATED APPLICATIONS

This application claims priority to Chinese Patent Application No.201710840112.1, filed with the State Intellectual Property Office of the People's Republic of China (SIPO) on Sep. 18, 2017, the content of which is incorporated herein by reference in its entirety.

### TECHNICAL FIELD

The present disclosure relates to the field of data processing technology, specifically relates to the field of electronic map technology, and more specifically relates to a method and apparatus for querying information.

### BACKGROUND

Electronic maps (also known as digital maps) are maps stored and queried digitally using computer technology. Electronic maps can be easily installed into smart devices, providing great convenience in daily travel and trips. With the development of science and technology, the electronic maps can provide more and more services. In addition to a basic road information displaying function, the electronic maps can also provide the traffic condition for each road segment in real time, facilitating users selecting driving routes according to actual needs.

An electronic map contains massive real-time data, which can provide a user with real-time traffic information of each road segment and play an important role in the daily travel of the user. Since the road information often change, the data acquisition apparatus of the electronic map needs to constantly collect real-time road information, and integrate the real-time traffic information into the electronic map in time. However, the real-time road information has massive data, the processing of data consumes much time, and real-time information errors caused by information delay may occur. At the same time, when the user reports an error in the information provided by the electronic map, technical personnel needs to retrieve a large amount of data to verify the error, only when the error is verified the prompt information in the electronic map can be corrected, which further reduces the accuracy of the prompt information provided by the electronic map.

### SUMMARY

The objective of embodiments of the present disclosure is to propose an improved method and apparatus for querying information, to solve the technical problem mentioned in the foregoing Background section.

In a first aspect, the embodiments of the present disclosure provide a method for querying information. The method includes: acquiring a driving route, a driving record video, and a record file, the driving route used to record route information corresponding to an actual driving route on an electronic map, the driving record video is used to record video information during an actual driving course corresponding to the driving route, and the record file is used to record at least one piece of event information different from prompt information provided by the electronic map during the actual driving course corresponding to the driving route, the event information including time information, location information and event content, and the prompt information includes at least one of the following: traffic congestion information, traffic light information, or road construction information; reading the event information in the record file, acquiring driving information corresponding to the event information from the driving record video, and acquiring pending prompt information provided by the electronic map corresponding to the event information and the driving route, the driving information including a driving image and/or a video clip; and establishing a corresponding relationship between the event information, the driving information, and the pending prompt information, and establishing an information query table based on the corresponding relationship.

In some embodiments, the acquiring driving information corresponding to the event information from the driving record video includes: extracting the time information from the event information, and searching in the driving record video for a time stamp corresponding to the time information; and extracting, at the time stamp, the event content from the event information, and acquiring the driving information according to an event category of the event content, wherein the event category includes at least one of the following: navigation error information, traffic congestion error information, or road construction error information.

In some embodiments, the acquiring the driving information at the time stamp according to an event category of the event content includes: acquiring a video corresponding to a first set time period preceding the time stamp and/or a video corresponding to a second set time period succeeding the time stamp in the driving record video, in response to the event category being the navigation error information category; acquiring an image corresponding to the time stamp in the driving record video, in response to the event category not being the navigation error information category.

In some embodiments, the acquiring pending prompt information provided by the electronic map corresponding to the event information and the driving route includes: extracting the location information from the event information, and setting a location stamp corresponding to the location information on the driving route; and querying the pending prompt information provided by the electronic map corresponding to the location stamp and the time information.

In a second aspect, the embodiments of the present disclosure provide an apparatus for querying information. The apparatus includes: an information acquisition unit, configured to acquire a driving route, a driving record video, and a record file, wherein the driving route is used to record route information corresponding to an actual driving route on an electronic map, the driving record video is used to record video information during an actual driving course corresponding to the driving route, and the record file is used to record at least one piece of event information different from prompt information provided by the electronic map during the actual driving course, the event information including time information, location information and event content, and the prompt information includes at least one of the following: traffic congestion information, traffic light information, or road construction information; an information search unit, configured to read the event information in the record file, acquire driving information corresponding to the event information from the driving record video, and acquire pending prompt information provided by the electronic map corresponding to the event information and the driving route, the driving information including a driving image and/or a video clip; and an information query table establishing unit, configured to establish a corresponding relationship between the event information, the driving information, and the pending prompt information, and establish an information query table based on the corresponding relationship.

In some embodiments, the information search unit includes: a time stamp search subunit, configured to extract the time information from the event information, and search in the driving record video; and a driving information acquisition subunit for a time stamp corresponding to the time information, configured to extract the event content from the event information, and acquire, at the time stamp, the driving information according to an event category of the event content, wherein the event category includes at least one of the following: navigation error information, traffic congestion error information, or road construction error information.

In some embodiments, the driving information acquisition subunit is configured to: acquire a video corresponding to a first set time period preceding the time stamp and/or a video corresponding to a second set time period succeeding the time stamp in the driving record video, in response to the event category being the navigation error information category; acquire an image corresponding to the time stamp in the driving record video, in response to the event category not being the navigation error information category.

In some embodiments, the information search unit includes: a location stamp search subunit, configured to extract the location information from the event information, and set a location stamp corresponding to the location information on the driving route; and a pending prompt information search subunit, configured to query the pending prompt information provided by the electronic map corresponding to the location stamp and the time information.

In a third aspect, the embodiments of the present disclosure provide a server, including: one or more processors; and a storage apparatus, for storing one or more programs, the one or more programs, when executed by the one or more processors, cause the one or more processors to implement the method for querying information according to the first aspect.

In a fourth aspect, the embodiments of the present disclosure provide a computer readable storage medium, storing a computer program thereon, the program, when executed by a processor, implements the method for querying information according to the first aspect.

The method and apparatus for querying information provided by the embodiments of the present disclosure, by acquiring driving information and pending prompt information through a driving route, a driving record video, and a record file, and establishing a correspondence table between the event information, the driving information and the pending prompt information, facilitate timely correction of the prompt information of the electronic map, and improve the accuracy of the prompt information of the electronic map.

### BRIEF DESCRIPTION OF THE DRAWINGS

After reading detailed descriptions of non-limiting embodiments given with reference to the following accompanying drawings, other features, objectives and advantages of the present disclosure will become more apparent:

FIG. 1 is an exemplary system architecture diagram to which the present disclosure may be applied;

FIG. 2 is a flowchart of a method for querying information according to an embodiment of the present disclosure;

FIG. 3 is a schematic diagram of an application scenario of the method for querying information according to the present disclosure;

FIG. 4 is a schematic structural diagram of an apparatus for querying information according to an embodiment of the present disclosure; and

FIG. 5 is a schematic structural diagram of a computer system adapted to implement a server of embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

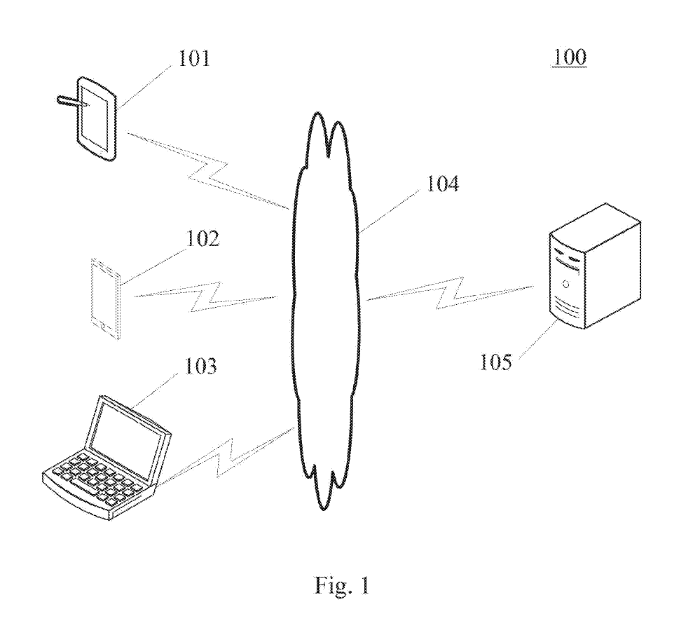

FIG. 1 shows an exemplary architecture of a system 100 in which a method or apparatus for querying information according to the embodiments of the present disclosure.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as wired or wireless transmission links, or optical fibers.

The user 110 may use the terminal devices 101, 102 and 103 to interact with the server 105 through the network 104, in order to transmit or receive messages, etc. Various communication client applications, such as electronic map application, information editing application, video recording application, message transmitting tools.

The terminal devices 101, 102 and 103 may be various electronic devices installed with an electronic map and having video recording and information recording function, including but not limited to, smart phones, tablet computers, laptop computers and desktop computers.

The server 105 may be a server performing data processing on the driving route, the driving record video and the record file sent from the terminal devices 101, 102 and 103. The server 105 may read event information from the record file, acquire driving information from the driving record video, and acquire a pending prompt information provided by the electronic map and corresponding to the event information and the driving route; and finally, establish an information querying table containing the event information, the driving information and the pending prompt information.

It should be noted that the method for querying information according to the embodiments of the present disclosure is generally executed by the server 105. Accordingly, an apparatus for querying information is generally installed on the server 105.

It should be appreciated that the numbers of the terminal devices, the networks and the servers in FIG. 1 are merely illustrative. Any number of terminal devices, networks and servers may be provided based on the actual requirements.

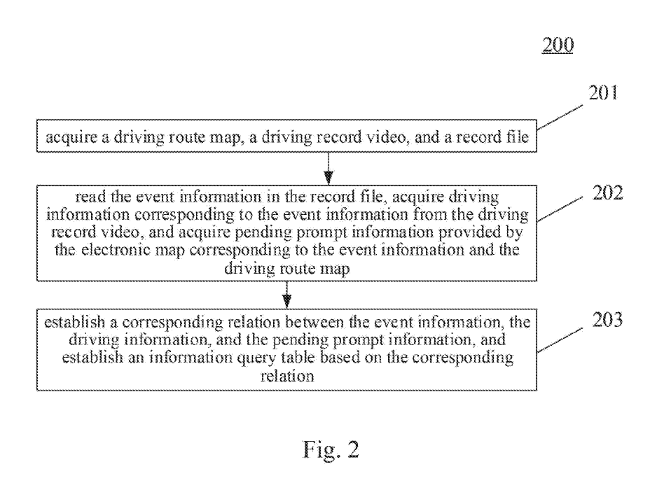

With further reference to FIG. 2, a flow 200 of the method for querying information according to an embodiment of the present disclosure is illustrated. The method for querying information includes the following steps:

Step 201, acquiring a driving route, a driving record video, and a record file.

In this embodiment, the electronic device (e.g., the server 105 as shown in FIG. 1) on which the method for querying information operate may acquire a driving route, a driving record video, and a record file through a wired connection or a wireless connection from the terminal devices 101, 102 and 103. The driving route is used to record route information on an electronic map corresponding to an actual driving route. The driving record video is used to record video information during an actual driving course corresponding to the driving route. The record file is used to record at least one event information during the actual driving course corresponding to the driving route and different from prompt information provided by the electronic map. The event information includes time information, location information and event content. The prompt information is used to provide traffic information at the current location and may include at least one of the following: traffic congestion information, traffic light information, or road construction information. Since the actual traffic changes in real time, the prompt information itself may also have a time attribute and a location attribute. The time attribute and the location attribute make it easy to find the prompt information. It should be noted that the wireless connection may include, but is not limited to, 3G/4G connection, WiFi connection, Bluetooth connection, WiMAX connection, Zigbee connection, UWB (ultra wideband) connection, and other wireless connections known by now or to be developed in the future.

The user carries the terminal devices 101, 102, 103 while driving. Through the electronic map installed on the terminal devices 101, 102, and 103, the user may not only acquire the route information, but also acquire the prompt information of the real-time road information provided by the electronic map. Alternatively, the prompt information may include traffic congestion information, traffic light information, road construction information, and the like. The terminal devices 101, 102, and 103 may also record the route information on the electronic map corresponding to the actual driving route, and obtain the driving route. During the actual driving course, the user may also record the video information during the actual driving course through the cameras on the terminal devices 101, 102, and 103, and obtain the driving record video corresponding to the driving route. When the user finds that the prompt information of the real-time road information provided by the electronic map is different from the actual road information, the corresponding event information may be recorded on the terminal device 101, 102, and 103. The event information may include time information, location information, and event content. The time information is used to record the time when the event occurs; the location information is used to record the location where the event occurs; and the event content is used to record the information of that the prompt information of the electronic map is different from the actual road condition. Since the road information is changing in real time, the user may send the corresponding driving route, the driving record video and the record file to the server 105 after recording a piece of event information, facilitating the timely correction of the prompt information of the electronic map. Alternatively, the user may also set the permission to acquire videos for the electronic map and provide a window for editing the record file. When the user finishes editing the record file, the driving route, the driving record video, and the record file are automatically sent to the server 105.

Step 202, reading the event information in the record file, acquiring driving information corresponding to the event information from the driving record video, and acquiring pending prompt information provided by the electronic map corresponding to the event information and the driving route.

In order to timely correct the prompt information on the electronic map, the server 105 first reads the event information in the record file after receiving the driving route, the driving record video, and the record file. The event information records the event information of that the prompt information provided by the electronic map is different from the actual driving course, that is, the prompt information provided by the electronic map may be in error. The event information includes time information, location information, and event content, and through the event information the prompt information that may be in error can be quickly and accurately located. In order to verify the authenticity of the event information, the driving information corresponding to the event information may be acquired from the driving record video. The driving information may include a driving image and/or a video segment. After that, the prompt information provided by the electronic map and corresponding to the event information and the driving route is took as the pending prompt information. At this time, the obtained event information, driving information and pending prompt information provide necessary information support for modifying the prompt information.

In some alternative implementations of the present embodiment, the acquiring driving information corresponding to the event information from the driving record video may include the following steps:

In the first step, the time information is extracted from the event information, and a time stamp corresponding to the time information is searched for in the driving record video.

The event information is recorded when the user finds that the prompt information of the real-time road information provided by the electronic map is different from the actual road information. That is, the time information contained in the event information is the time when the prompt information in an error. To this end, the time information may be extracted from the event information, and a corresponding time stamp (for example, xx o'clock xx minutes xx seconds) in the driving record video may be found based on the time information. The time stamp is used to mark the recording time of the image in the driving record video.

In the second step, the event content is extracted from the event information, and the driving information is acquired at the time stamp according to the event category of the event content.

The event content records the information of that the prompt information provided by the electronic map is different from the actual road information. According to the information content recorded in the event content, the event content may be divided into multiple event categories. The event category includes at least one of the following: navigation error information, traffic congestion error information, or road construction error information. For different event categories, the driving information that needs to be acquired may be different, depending on actual needs.

In some alternative implementations of the present embodiment, the acquiring, at the time stamp, the driving information according to the event category of the event content may include: acquiring a video corresponding to a first set time period preceding the time stamp and/or a video corresponding to a second set time period succeeding the time stamp in the driving record video, when the event category is the navigation error information category, in the negative, acquiring an image corresponding to the time stamp in the driving record video.

As may be seen from the above description, for different event categories, the driving information that needs to be acquired may be different. In this embodiment, when the event category is the navigation error information category, a video corresponding to a first set time period preceding the time stamp and/or a video corresponding to a second set time period succeeding the time stamp in the driving record video may be acquired, to correct the navigation information through the information recorded in the video. For example, a time stamp (for example, 13:25:00) may be used as the starting time, and a video of the first set time period (for example, 1 minute) may be selected forward (a video between 13:24:00 and 13:25:00) as the driving information, or a video of the second set time period (for example, 2 minutes) may be selected backward (a video between 13:25:00 and 13:27:00) as the driving information. The lengths of the first time period and the second time period may be set as required. For other event categories that can be determined without videos, the images corresponding to the time stamps may be directly acquired.

Acquiring a corresponding video or image according to the event category may be determined as required. In some alternative implementations, the corresponding video and image may be set to be acquired at the same time according to a certain event category.

In some alternative implementations of the present embodiment, the acquiring pending prompt information provided by the electronic map and corresponding to the event information and the driving route may include the following steps:

In the first step, the location information is extracted from the event information, and a location stamp corresponding to the location information is set on the driving route.

The event information may also include location information, which is used to record the location of the user when the event occurs. At the same time, the same location, different driving directions or different driving routes may also have different road conditions. Therefore, when searching for the prompt information, the actual driving route should also be considered, and further the location stamp corresponding to the location information is set on the driving route.

In the second step, the pending prompt information provided by the electronic map and corresponding to the location stamp and the time information is queried.

Due to the large amount of the prompt information provided by the electronic map, the prompt information may be queried according to time information or location information. At the same time, the pending prompt information corresponding to the event information can be determined according to the location stamp and the time information.

Step 203, establishing a corresponding relationship between the event information, the driving information, and the pending prompt information, and establishing an information query table based on the corresponding relationship.

After the server 105 obtains the event information, the driving information, and the pending prompt information, the event information, the driving information, and the pending prompt information may be respectively saved in different information storage sections (or folders) on the server 105. Then, the corresponding relationship between the event information, the driving information, and the pending prompt information may be established by establishing a shortcut link or the like, to facilitate the mutual retrieval between information. In order to facilitate the verification and modification to the information, an information query table may also be established based on the corresponding relationship. An optional approach is: first generating a blank table, and then setting, in the table, an event information display window, a driving information display window and a pending prompt information display window for the event information, the driving information and the pending prompt information respectively; then, the event information (or the shortcut of the corresponding event information) is loaded into the event information display window. The event information display window may include a time information column, a location information column, and an event content column to display the time information, the location information, and the event content included in the event information in the time information column, the location information column, and the event content column, respectively. The driving information includes both video and image formats. For convenient viewing of videos or images, a window size adjustment option may also be set on the driving information display window. The pending prompt information display window is used to display the pending prompt information found by the server 105. In the information query table, when a certain piece of event information is selected, the driving information or the pending prompt information corresponding to the event information is simultaneously displayed. Similarly, when a certain piece of driving information is selected, the event information and the pending prompt information corresponding to the driving information are also displayed at the same time. In this way, the process of manually searching for information by a technician is avoided, the efficiency of information query, information verification and information modification is greatly improved, and the accuracy of the prompt information provided by the electronic map is improved.

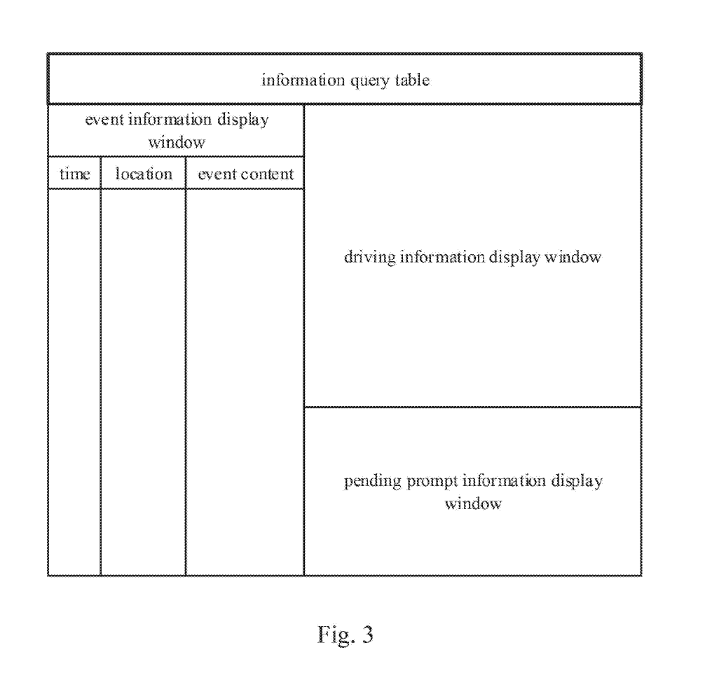

With further reference to FIG. 3, a schematic diagram of an application scenario of the method for querying information according to the present embodiment is illustrated. In the application scenario of FIG. 3, the server 105 first acquires the driving route, the driving record video, and the record file, then reads the event information in the record file, acquires driving information corresponding to the event information from the driving record video, and acquires pending prompt information provided by the electronic map and corresponding to the event information and the driving route, finally establishes a corresponding relationship between the event information, the driving information, and the pending prompt information, and establishes an information query table based on the corresponding relationship. A fast query between the event information, the driving information, and the pending prompt information is implemented.

The method provided by the above embodiment of the present disclosure acquires driving information and pending prompt information through a driving route, a driving record video, and a record file, and establishes a correspondence table between the event information, the driving information and the pending prompt information, which facilitates timely correction of the prompt information of the electronic map, and improves the accuracy of the prompt information of the electronic map.

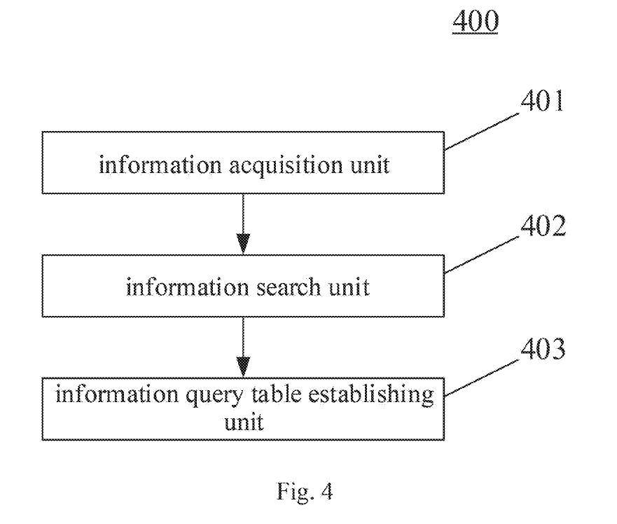

With further reference to FIG. 4, as an implementation to the method shown in the above figures, the present disclosure provides an embodiment of an apparatus for querying information. The apparatus embodiment corresponds to the method embodiment shown in FIG. 2, and the apparatus may specifically be applied to various electronic devices.

As shown in FIG. 4, the apparatus 400 for querying information of the present embodiment may include: an information acquisition unit 401, an information search unit 402 and an information query table establishing unit 403. The information acquisition unit 401 is configured to acquire a driving route, a driving record video, and a record file, wherein the driving route is used to record route information on an electronic map corresponding to an actual driving route, the driving record video is used to record video information during an actual driving course corresponding to the driving route, and the record file is used to record at least one event information during the actual driving course corresponding to the driving route and different from prompt information provided by the electronic map, the event information including time information, location information and event content, and the prompt information includes at least one of the following: traffic congestion information, traffic light information, or road construction information. The information search unit 402 is configured to read the event information in the record file, acquire driving information corresponding to the event information from the driving record video, and acquire pending prompt information provided by the electronic map corresponding to the event information and the driving route, the driving information including a driving image and/or a video clip. The information query table establishing unit 403 is configured to establish a corresponding relationship between the event information, the driving information, and the pending prompt information, and establish an information query table based on the corresponding relationship.

In some alternative implementations of the present embodiment, the information search unit 402 may include: a time stamp search subunit (not shown in the figure) and a driving information acquisition subunit (not shown in the figure.) The time stamp search subunit is configured to extract the time information from the event information, and search in the driving record video for a time stamp corresponding to the time information. The driving information acquisition subunit is configured to extract the event content from the event information, and acquire, at the time stamp, the driving information according to an event category of the event content, wherein the event category includes at least one of the following: navigation error information, traffic congestion error information, or road construction error information.

In some alternative implementations of the present embodiment, the driving information acquisition subunit may be configured to: acquire a video corresponding to a first set time period preceding the time stamp and/or a video corresponding to a second set time period succeeding the time stamp in the driving record video, when the event category is the navigation error information category, in the negative, acquire an image of the corresponding time stamp in the driving record video.

In some alternative implementations of the present embodiment, the information search unit 402 may include: a location stamp search subunit (not shown in the figure) and a pending prompt information search subunit (not shown in the figure.) The location stamp search subunit is configured to extract the location information from the event information, and set a location stamp corresponding to the location information on the driving route. The pending prompt information search subunit is configured to query the pending prompt information provided by the electronic map corresponding to the location stamp and the time information.

The present embodiment also provides a server, including: one or more processors; and a storage apparatus, for storing one or more programs, the one or more programs, when executed by the one or more processors, cause the one or more processors to implement the method for querying information.

The present embodiment also provides a computer readable storage medium, storing a computer program thereon, the program, when executed by a processor, implements the method for querying information.

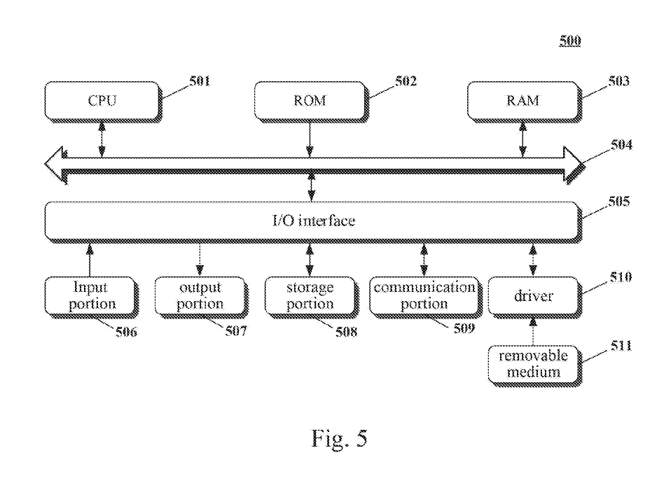

Referring to FIG. 5, a schematic structural diagram of a computer system 500 adapted to implement a server of the embodiments of the present disclosure is shown. The server shown in FIG. 5 is merely an example and should pose any limitations on the function and usage range of the embodiments of the present disclose.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a cathode ray tube (CRT), a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A driver 510 is also connected to the I/O interface X05 as required. A removable medium 511, such as a magnetic disk, an optical disk, a magneto-optical disk, and a semiconductor memory, may be installed on the driver 510, to facilitate the retrieval of a computer program from the removable medium 511, and the installation thereof on the storage portion 508 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 509, and/or may be installed from the removable media 511. The computer program, when executed by the central processing unit (CPU) 501, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising an information acquisition unit, an information query unit and an information query table establishing unit, where the names of these units or modules do not in some cases constitute a limitation to such units or modules themselves. For example, the information query table establishing unit may also be described as “a unit for establishing an information query table based on the event information, the driving information and the pending prompt information.”

In another aspect, the present disclosure further provides a computer-readable storage medium. The computer-readable storage medium may be the computer storage medium included in the apparatus in the above described embodiments, or a stand-alone computer-readable storage medium not assembled into the apparatus. The computer-readable storage medium stores one or more programs. The one or more programs, when executed by a device, cause the device to: acquire a driving route, a driving record video, and a record file, wherein the driving route is used to record route information on an electronic map corresponding to an actual driving route, the driving record video is used to record video information during an actual driving course corresponding to the driving route, and the record file is used to record at least one event information during the actual driving course corresponding to the driving route and different from prompt information provided by the electronic map, the event information comprising time information, location information and event content, and the prompt information comprises at least one of: traffic congestion information, traffic light information, or road construction information; read the event information in the record file, acquiring driving information corresponding to the event information from the driving record video, and acquiring pending prompt information provided by the electronic map corresponding to the event information and the driving route, the driving information comprising a driving image and/or a video clip; and establish a corresponding relationship between the event information, the driving information, and the pending prompt information, and establishing an information query table based on the corresponding relationship.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for querying information, the method comprising:
acquiring a driving route, a driving record video, and a record file, the driving route used to record route information corresponding to an actual driving route on an electronic map, the driving record video is used to record video information during an actual driving course corresponding to the driving route, and the record file is used to record at least one piece of event information different from prompt information provided by the electronic map during the actual driving course corresponding to the actual route, the event information comprising time information, location information and event content, and the prompt information comprises at least one of: traffic congestion information, traffic light information, or road construction information;
reading the event information in the record file, acquiring driving information corresponding to the event information from the driving record video, and acquiring pending prompt information provided by the electronic map corresponding to the event information and the driving route, the driving information comprising a driving image and/or a video clip; and
establishing a corresponding relationship between the event information, the driving information, and the pending prompt information, and establishing an information query table based on the corresponding relationship,
wherein the method is performed by at least one processor.

2. The method according to claim 1, wherein the acquiring driving information corresponding to the event information from the driving record video comprises:
extracting the time information from the event information, and searching in the driving record video for a time stamp corresponding to the time information; and
extracting the event content from the event information, and acquiring, at the time stamp, the driving information according to an event category of the event content, wherein the event category comprises at least one of: navigation error information, traffic congestion error information, or road construction error information.

3. The method according to claim 2, wherein the acquiring, at the time stamp, the driving information according to an event category of the event content comprises:
acquiring a video corresponding to a first set time period preceding the time stamp and/or a video corresponding to a second set time period succeeding the time stamp in the driving record video, in response to the event category being the navigation error information category; acquiring an image corresponding to the time stamp in the driving record video, in response to the event category not being the navigation error information category.

4. The method according to claim 1, wherein the acquiring pending prompt information provided by the electronic map corresponding to the event information and the driving route comprises:
extracting the location information from the event information, and setting a location stamp corresponding to the location information on the driving route; and
querying the pending prompt information provided by the electronic map corresponding to the location stamp and the time information.

5. An apparatus for querying information, the apparatus comprising:
at least one processor; and
a memory storing instructions, the instructions when executed by the at least one processor, cause the at least one processor to perform operations, the operations comprising:
acquiring a driving route, a driving record video, and a record file, the driving route used to record route information corresponding to an actual driving route on an electronic map, the driving record video is used to record video information during an actual driving course corresponding to the driving route, and the record file is used to record at least one piece of event information different from prompt information provided by the electronic map during the actual driving course corresponding to the actual route, the event information comprising time information, location information and event content, and the prompt information comprises at least one of: traffic congestion information, traffic light information, or road construction information;
reading the event information in the record file, acquiring driving information corresponding to the event information from the driving record video, and acquiring pending prompt information provided by the electronic map corresponding to the event information and the driving route, the driving information comprising a driving image and/or a video clip; and
establishing a corresponding relationship between the event information, the driving information, and the pending prompt information, and establishing an information query table based on the corresponding relationship.

6. The apparatus according to claim 5, wherein the acquiring driving information corresponding to the event information from the driving record video comprises:
extracting the time information from the event information, and searching in the driving record video for a time stamp corresponding to the time information; and
extracting the event content from the event information, and acquiring, at the time stamp, the driving information according to an event category of the event content, wherein the event category comprises at least one of: navigation error information, traffic congestion error information, or road construction error information.

7. The apparatus according to claim 6, wherein the acquiring, at the time stamp, the driving information according to an event category of the event content comprises:
acquiring a video corresponding to a first set time period preceding the time stamp and/or a video corresponding to a second set time period succeeding the time stamp in the driving record video, in response to the event category being the navigation error information category; acquire an image corresponding to the time stamp in the driving record video, in response to the event category not being the navigation error information category.

8. The apparatus according to claim 5, wherein the acquiring pending prompt information provided by the electronic map corresponding to the event information and the driving route comprises:
extracting the location information from the event information, and setting a location stamp corresponding to the location information on the driving route; and
querying the pending prompt information provided by the electronic map corresponding to the location stamp and the time information.

9. A non-transitory computer readable storage medium storing a computer program, wherein the computer program, when executed by a processor, cause the processor to perform operations, the operation comprising:
acquiring a driving route, a driving record video, and a record file, the driving route used to record route information corresponding to an actual driving route on an electronic map, the driving record video is used to record video information during an actual driving course corresponding to the driving route, and the record file is used to record at least one piece of event information different from prompt information provided by the electronic map during the actual driving course corresponding to the actual route, the event information comprising time information, location information and event content, and the prompt information comprises at least one of: traffic congestion information, traffic light information, or road construction information;
reading the event information in the record file, acquiring driving information corresponding to the event information from the driving record video, and acquiring pending prompt information provided by the electronic map corresponding to the event information and the driving route, the driving information comprising a driving image and/or a video clip; and
establishing a corresponding relationship between the event information, the driving information, and the pending prompt information, and establishing an information query table based on the corresponding relationship.
